(19) United States
(12) Patent Application Publication
(10) Pub. No.: US 2016/0248864 A1
(43) Pub. Date: Aug. 25, 2016

(54) SOCIAL NETWORKING GAMES INCLUDING IMAGE UNLOCKING AND BI-DIRECTIONAL PROFILE MATCHING

(71) Applicant: UNRAVEL, LLC, San Jose, CA (US)

(72) Inventors: Jason LOIA, San Jose, CA (US); Kenny YAN, San Jose, CA (US); Charles PACKER, Redwood City, CA (US); Wayne TOW, Mountain View, CA (US); Aisha THIESSEN, Mountain View, CA (US); Gary SCHOFIELD, Los Altos, CA (US)

(73) Assignee: UNRAVEL, LLC, San Jose, CA (US)

(21) Appl. No.: 14/946,365

(22) Filed: Nov. 19, 2015

Related U.S. Application Data
(60) Provisional application No. 62/081,840, filed on Nov. 19, 2014.

(51) Int. Cl. H04L 29/08; A63F 9/18; G06Q 30/02; H04L 12/58; G06Q 50/00

(52) U.S. Cl. CPC H04L 67/22; H04L 67/306; H04L 51/32; G06Q 50/01; G06Q 30/0209; A63F 9/18

(57) ABSTRACT

The present subject matter relates to systems and methods for providing enhanced social networking, or other games, that include various profile unlocking techniques and/or bi-directional profile matching. In some examples, a game-like experience may be provided in which an “unveiling” or “unraveling” mechanic is used, e.g. to clarify or unlock one or more blurred user-uploaded photos, or other user-related information, in a mobile social networking, or other, application. In some examples, a game-like experience may be provided in which profile unveiling mechanics are used with a virtual currency in a mobile social networking, or other, application. A questionnaire-based bi-directional profile matchmaking and recommendation algorithm may also be provided for use in a mobile social networking, or other, application.

### RELATED APPLICATIONS

The present application claims priority under 119(e) to U.S. Provisional Application 62/081,840, filed Nov. 19, 2014, entitled “SOCIAL NETWORKING GAMES INCLUDING IMAGE UNLOCKING AND BI-DIRECTIONAL PROFILE MATCHING,” the contents of which are hereby incorporated by reference in their entirety for all purposes.

### BACKGROUND

Social networking and gaming applications include mechanisms for forming connections with other users, such as “friending” other users. Typically, this includes one user sending a “friend” request to another user, and the other user accepting or rejecting the request. Once a link is established, permissions that the user(s) have may be adjusted, e.g. allowing the “friends” to view otherwise restricted content, comment on and/or view friends' posts, and/or send chat messages, gaming invitations, etc. to their “friends.” However, such methodologies suffer from a number of drawbacks, such as limiting the ways that connections and/or information sharing may be established to a binary “yes” or “no” answer by the receiving user, limiting content and/or shared features to one category of friends (i.e. all or nothing), limiting the information that a receiving user may be able to see about a requesting user, and/or requiring the receiving user to approve every request before sharing information.

### SUMMARY

The present invention generally relates to systems and methods for providing enhanced social networking, or other games, that include various profile unlocking techniques and/or bi-directional profile matching. In some examples, a game-like experience may be provided in which an “unveiling” or “unraveling” mechanic is used, e.g. to clarify or unlock one or more blurred user-uploaded photos, or other user-related information, in a mobile social networking, or other, application.

In some examples, a game-like experience may be provided in which profile unveiling mechanics are used with a virtual currency in a mobile social networking, or other, application.

In some examples, a questionnaire-based bi-directional profile matchmaking & recommendation algorithm may be provided for use a mobile social networking, or other, application.

According to further aspects of the invention, a computerized system configured to exchange information among a plurality of users over a network may be provided including one or more of a network communication module configured to exchange information with the plurality of users over the network; a profile generating module configured to generate a profile including user information, answers to one or more questions, and/or a plurality of images associated with a first user; an obfuscation module configured to obscure at least one of the plurality of images; a matching module configured to present a plurality user profiles to a second user, and to receive a selection of at least one of the user profiles from the second user; and/or a de-obfuscation module configured to present the obscured version of the at least one image to the second user, to present at least one of the questions to the second user, and to present the unobscured version of the at least one image to the second user based on receiving an answer to the at least one of the questions.

In some examples, the matching module may be further configured to send an alert to the user associated with the selected user profile based on at least one of presenting the obscured version of the at least one image to the second user, presenting the a question to the second user, receiving the answer to the at least one of the questions, and/or presenting the unobscured version of the at least one image to the second user.

In some examples, the alert may include instructions that are operable to allow the second user to initiate communication with the first user.

In some examples, the network communication module may be configured to exchange information with mobile applications being operated by the plurality of users.

In some examples, the profile generating module may be configured to associate specific questions with specific images such that answering a specific question unlocks the image associated with that question.

In some examples, the obfuscation module may be configured to obscure the at least one of the plurality of images by blurring the image, changing color, brightness and/or hue of the image, changing the resolution of the image, or other image processing techniques.

In some examples, the matching module may be configured to present the plurality of user profiles to the second user based on an algorithm that compares user and/or usage information about the second user with user and/or usage information associated with the plurality of user profiles.

In some examples, the de-obfuscation module may be configured to present the unobscured version of the at least one image to the second user regardless of whether the received answer is correct, and to award virtual currency points to the second user based on a correct answer.

In some examples, the user profiles each include a plurality of images associated with each user, and each of the pictures can be unlocked by second users answering a question associated with each picture.

According to further aspects of the invention, a computerized system configured to exchange information among a plurality of users over a network may include one or more of a network communication module configured to exchange information with the plurality of users over the network; a profile generating module configured to generate a profile including user information, answers to one or more questions, and/or a plurality of images associated with a first user; an obfuscation module configured to obscure at least one of the plurality of images;

and a de-obfuscation module configured to present the obscured version of the at least one image to a second user, to present at least one of the questions to the second user, and to present the unobscured version of the at least one image to the second user based on receiving an answer to the at least one of the questions.

According to further aspects of the invention, a computerized system configured to exchange information among a plurality of users over a network may include one or more of a matching module configured to present a plurality user profiles to a first user, and to receive a selection of at least one of the user profiles from the first user; and a game module configured to present first information related to the selected profile, and to allow the first user to obtain additional information related to the selected profile via at least one of answering one or more questions or performing one or more tasks.

In some examples, the matching module may be further configured to send an alert to a second user associated with the selected user profile based on at least one of the first information being presented to the first user and/or the first user attempting to obtain the additional information,

In some examples, the alert may include instructions that are operable to allow the second user to initiate communication with the first user.

According to further aspects of the invention, a computerized system may include one or more of a network communication module configured to exchange information with the plurality of users over the network; a profile generating module configured to generate profiles for each of the users including user information, answers to one or more questions, and/or a plurality of images associated each user; a matching module configured to present a plurality user profiles to a first user, and to receive a selection of at least one of the user profiles from the first user; and a de-obfuscation module configured to present first information related to the selected profile, and to allow the first user to obtain additional information related to the selected profile via answering one or more questions.

In some examples, the matching module may be is further configured to send an alert to a second user associated with the selected user profile based on at least one of the first information being presented to the first user and/or the first user attempting to obtain the additional information.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the related technology. No attempt is made to show structural details of technology in more detail than may be necessary for a fundamental understanding of the invention and various ways in which it may be practiced. In the drawings:

FIG. 1 shows an overview of an exemplary user process flow performed by one or more network-enabled computer systems according to aspects of the invention.

FIG. 2 shows further details related to an exemplary user process flow for creating a profile by one or more network-enabled computer systems according to aspects of the invention.

FIG. 3 shows further details related to an exemplary user process flow for unraveling a profile using one or more network-enabled computer systems according to aspects of the invention.

FIG. 4 is a schematic diagram depicting an exemplary network-enabled computer system according to aspects of the invention.

FIG. 5 depicts an exemplary user profile file according to aspects of the invention.

FIG. 6 is a flow diagram including exemplary steps for creating and managing connections between user accounts according to aspects of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a server” is a reference to one or more servers and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

Aspects of the present subject matter have been used by the inventors to provide, for example, a mobile dating application that employs a unique combination of features designed to provide a “gamified,” high-quality matching experience for its users. While most dating applications fall into one of two categories, casual “Hot-or-Not/Hookup” or serious “Soul Mate Finder”, aspects of the present subject matter may find applicability in a “middle ground” that has significant advantages over known systems. More specifically, in some examples, embodiments may include combining visual cues with more in-depth personality-related features like might be found in a relationship application. In some examples, systems may provide engaging user experiences, without employing high-effort, in-depth personality profile questionnaires, like eHarmony® which can be time-intensive, cumbersome, and dry. Instead, by providing a “gamified” experience, which is highly entertaining and, at the same time, can be used to capture information about the user to generate high-quality matches.

Thus, in exemplary working embodiments, the inventors have achieved many objectives which were unsatisfied in the prior art, such as providing the first personal UGC trivia, picture-based social game, providing an engaging and interesting way to meet new people in a safe environment, providing match-making, beyond picture-hunting, via an interactive and engaging “peeling back” of user profile layers and thereby getting to know the real person. Such methods are also applicable to a range of social media and gaming applications, in which users seek to establish connections with other “friends,” gaming partners, etc.

In some examples, participating users can be awarded virtual currency, such as tokens and the like that can be redeemed in one or more applications, and that may be awarded based on, for example, correct answers, a number of people exploring a user's profile, etc.

The inventors have further found that, compared to existing applications, the present subject matter can readily be used to gauge how well someone knows their friends, gather and execute unique personal trivia-based information rapidly in the context of an enjoyable social game, provide a masked friends-discovery gameplay mode, allow for the specified unlocking of bi-directional chat, and providing an innovative matchmaking & recommendation engine.

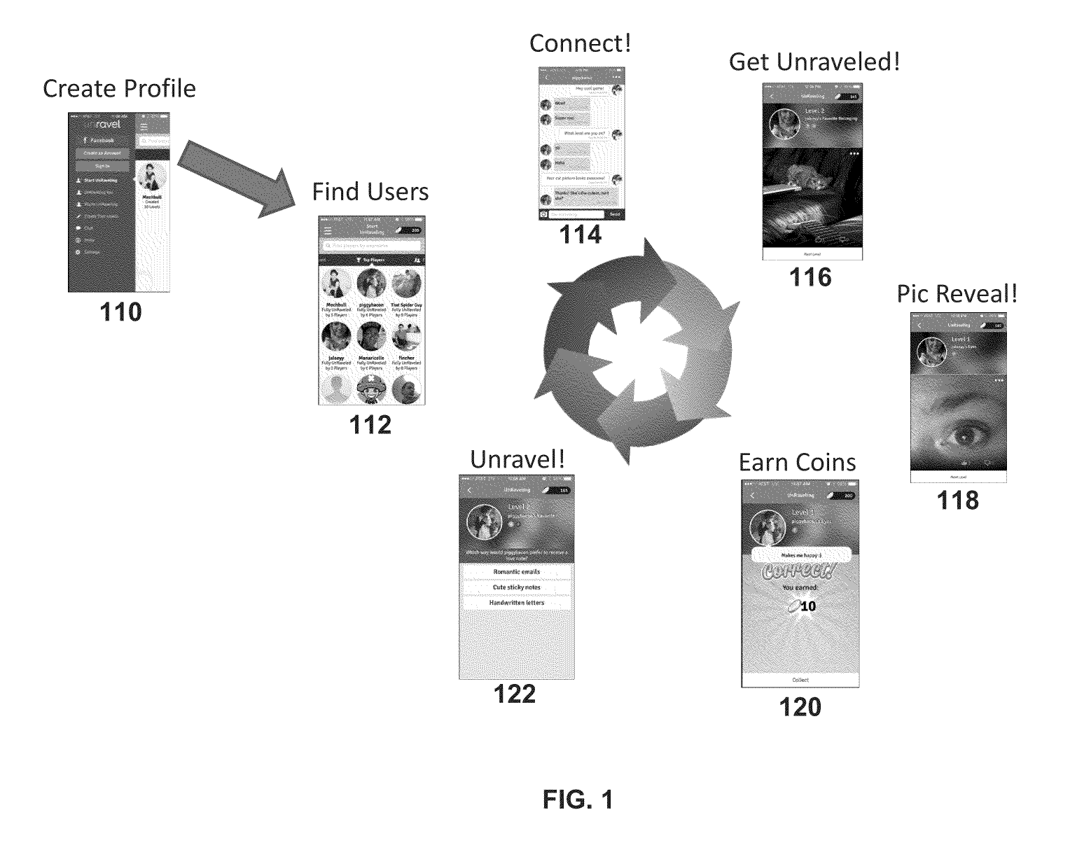

FIG. 1 shows an overview of a user process flow according to aspects of the invention. Each operation depicted therein may represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes. Additionally, any specific reference to one or more operations being capable of being performed in a different order is not to be understood as suggesting that other operations may not be performed in another order.

FIG. 1 also depicts exemplary GUI illustrating various aspects of user registration, profile management, and interaction according to aspects of the disclosure. The elements depicted as included in these items are not intended to be limiting and it is to be understood that the GUIs in FIG. 1, and other figures, can take on many different forms, e.g. in the context of web browsers, or other applications, running on user computing devices and the like.

As shown in FIG. 1, a process may begin with presentation of a “Create Profile” screen 110, which can be included as part of a website, application page, or other process running on a user device. In embodiments, a user may be asked, for example, when the user first downloads an application such as “Unravel” discussed herein, to create a profile, comprising a number, e.g. about 10, levels. Creation of a profile may be handled in a relatively quick manner, and may include collection of two categories of information: (1) “Personal Factoids” which are gathered through a series of multiple-choice-answer questions prompted by the application, each set of Level questions building from innocuous fun facts to more in-depth, insightful questions relating to Life, Dating, Relationships, Family, etc., and (2) “Fun Selfies/Videos” which the user uploads at the end of each Level as the “Picture Reveal” and range from themes like “Me being goofy” to “Me at a Party”. The Profile Creation may be designed to take less than a few minutes to fill out, e.g. by including a mix of short form multiple choice, easy-to-answer questions, and purposefully themed picture upload prompted themes which would be readily available on the user's device in their picture gallery, or Facebook and Instagram libraries.

The user's answers to questions may be stored at a server providing the website, application and/or service. Typically, answers will be stored in association with a user profile, as discussed further herein, such that when another user seeks to “unlock” user information, the server can present the corresponding questions to the requesting user, and compare the requesting user's answers to the answers associated with the user profile.

The images (or images extracted from videos) that have been uploaded may then be “blurred” or otherwise altered to form an obscured version of the image, so other users can get a glimpse of it but they cannot see it clearly until they've answered questions (correctly or incorrectly). In other cases, the server, or client-side application, may be configured to obscure the images at the time they are originally served to a requesting user, and to correct the image(s) after the question(s) are answered.

After creating a user profile, the user may select a “Find Users” function, e.g. by selecting an icon, pull down menu, etc., in order to search and/or browse other user's information. In some embodiments, a “Find Users” GUI 112 may be presented that allows the user to browse other profiles, e.g. to see who they want to gain additional information on, or “unravel.” A carousel, or other selectable combination of user profiles, may be presented to a user via a mobile application based on a matching algorithm that takes into account, for example, the way the user has answered questions (in setting up their profile or browsing other user's information), the way others have answered their questions, the user's physical proximity to the other user(s), the frequency of the activity of the other users, and/or selectable filters (which may be established in the user profile or on the fly in GUI 112) such as age range, gender, etc. The user can swipe to see more optional profiles, and tap and hold a profile to see a representation of their additional information, such as blurred pictures, clues about further personal information, etc.

In some examples, users may be allowed limited connectivity with other users that they have selected, but not yet answered questions about, or otherwise gained access to additional information and/or functions. For example, a GUI 114 may include limited messaging capability to send messages to a selected user, and/or may present limited profile information about the selected user. GUI 114 may also include selectable options for initiating the “unravel” process. GUI 114 may take many forms that allow users to initiate contact with other users. For example, in a chat window between connected users, one of the users may insert a link (e.g. depicted as an obscured picture) of another user, which can be used to start an “unravel” process. Thus, users can easily share and recommend established friends to other users, without exposing restricted/additional information until the “unravel” process is completed.

In some examples, details of the additional information may all be locked until the user answers questions associated with the additional information to “unravel” them, thereby investing some time in getting to know things about the other user before one is “rewarded” with the unveiling of a clear picture, or otherwise granted access to additional information.

In some examples, when one user selects another user's profile (e.g. from GUI 112), or starts to unlock additional user information, an alert may be sent to the other user to let them know that someone is inspecting or “unraveling” their profile. In some cases, the alert may allow the other user to inspect or start unraveling the first user's profile and/or may allow the other user to initiate communication with the first user, e.g. via an instant message or other means.

Once a (first) user has chosen a profile (of a second user) to “unravel,” e.g. from GUI 112 or 114, the application may allow the first user to start guessing at how the second user answered their profile questions, including presenting a GUI 116 that includes obscured data and one or more questions for the requesting user to answer. For example, the application may display a copy of the same question that was asked when the profile-user created the profile, along with a list of possible answers for the requesting user to select from. The requesting user can then select from the available responses, and a determination may be made (locally on the client-side application, or on the server) as to whether the selected answer is correct, i.e. if it corresponds to the answer stored in association with the user profile.

When a first user has answered the question(s) in a level correctly about another user, the first user may be rewarded with a Picture Reveal (or other information unlock) of that level, e.g. in GUI 118, and the application may remove a blur or other obscurity from the image or data, thereby revealing the image or data in full clarity to the first user. In some examples, the information may be unobscured or made available for access incrementally based on a number of questions and answers. Incorrect answers may also be used in some cases (e.g. depending on user-defined preferences) to partially or completely unobscure/access the information.

In some examples, if the first user guesses correctly, they can earn virtual currency within the social networking environment, such as “Charm Points.” The awarding of points may be communicated to the user via GUI 120, which may also include embedded functionality for using the points. If the first user guesses wrong, the virtual currency may be deducted. These points may be used, for example, to unlock other perks or features in the application such as a QuickChat (allowing a connection to another user), or QuickUnlock (allowing immediate access to some additional profile information), etc. In some examples, the environment may be configured to allow users to freely earn virtual currency points, e.g. by unraveling users and guessing correctly, and can also be purchased through the appstore.

As mentioned previously, once the first user accesses the profile of a second user or starts unraveling the second user's profile, the second user may receive a notification that the first user is accessing or unraveling them. This may include presenting the second user with a GUI 122 (either automatically or based on selection by the second user), which is configured to allow the second user to immediately start unraveling the first user. If the second user looks at the first user's profile and decides to unravel it, this may be considered a Mutual Unravel (a Match) which signifies mutual interest and a Chat Window (or other communication) may be opened in the application, such as in GUI 114, for the first and second users to communicate directly if they so wish. In some examples, communication between the users may be blocked up to this point, e.g. users cannot chat with each other without a mutual unraveling. The chat window may also allow users to upload pictures and videos in the chat thread.

Thus, according to aspects of the invention, a social networking environment may be provided including a combination of one or more of personal factoids plus pictures/video in a user profile, unique bi-directional matching algorithm, game-like levels of increasing personality Q&A which a user guesses at to unveil/unlock blurred or otherwise obscured pictures or other information to full clarity as the reward, the use of virtual currency to reward, and allow, actions, and/or a chat function which may be opened once a mutual match occurs.

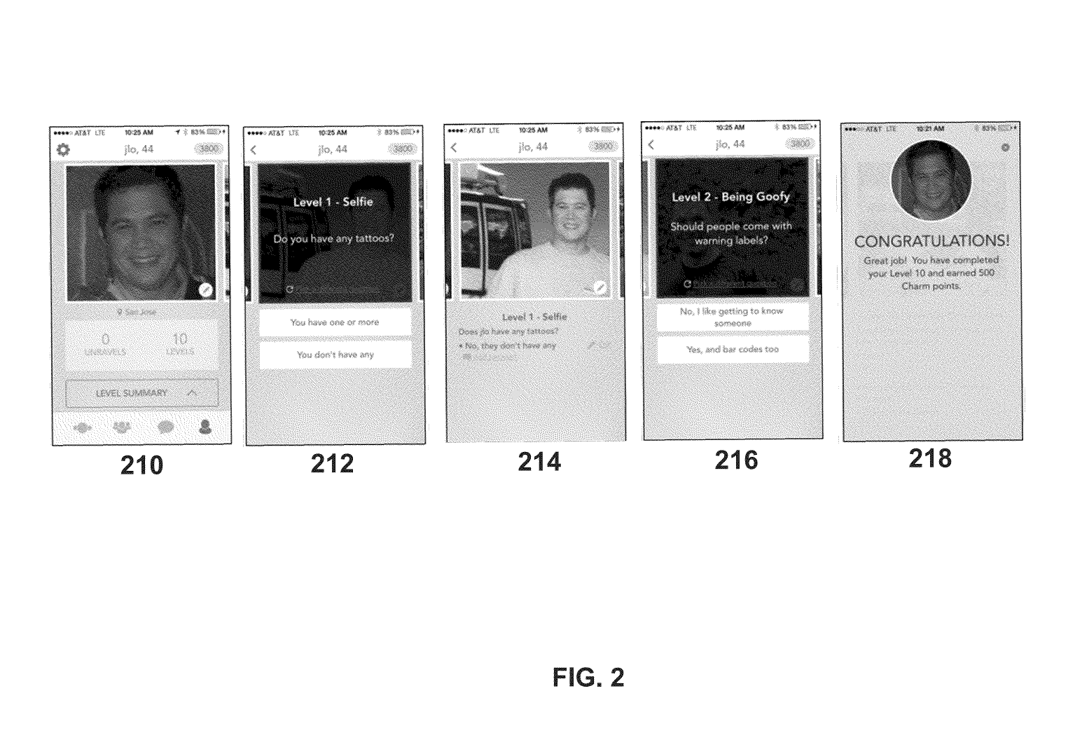

FIG. 2 shows further details related to a user process flow, and exemplary GUI, for creating a profile according to aspects of the invention. As shown in FIG. 2, a first user may begin creating a profile in 210, e.g. by uploading an image that will be presented (unobscured) whenever other users are browsing the first user's profile. In 212, the application may present the first user with a question and a number of optional responses to select between, or allow the user to enter their own answer (e.g. for a 1^{st} level). Once the user selects (or enters) the desired response, the application may proceed with 214, in which the first user is allowed to upload, or associate an existing image or other information with the question/answer from 212. The application may then proceed with 216, in which another question and possible responses are presented to the first user (e.g. for a 2^{nd} or subsequent level), and another image or other information may be linked to the 2^{nd} or subsequent level. The user may be allowed to repeat these steps any number of times before completion of the profile in 218. In addition to answering predetermined questions, the user may also be allowed to input their own questions and corresponding answers, providing additional flexibility to the overall system.

In some examples, the information uploaded by the user may be associated with categories, or other classifications, related to the content of the information. For example, images associated with “hobbies,” “travel,” etc., may be categorized such that requesting users can unlock photos (or other information) related to that category, thereby allowing requesting users to unlock information reflecting specific subjects that interest them.

In some examples, completing the user profile may automatically award the user a number of virtual currency points. The number of points awarded may vary based on, for example, the number of questions, answers, photos, videos, or other information, that the user provides. That is, users may receive additional points for building more detailed and layered profiles, which encourages greater user interaction.

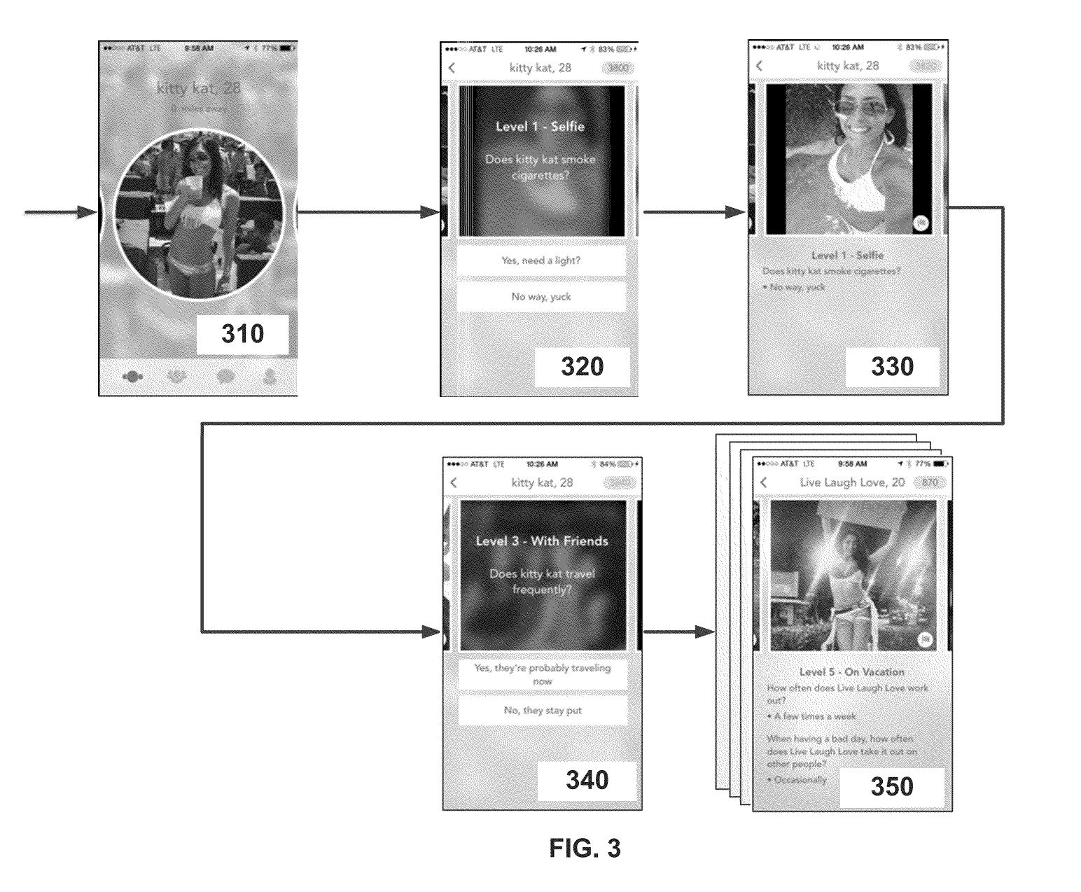

FIG. 3 shows further details related to a user process flow, and exemplary GUI, for unraveling a profile according to aspects of the invention. As shown in FIG. 3, in 310 a browsing user may be presented with one or more other user's profiles to browse through, based on a matching or other algorithm that identifies similar profiles to the second user. In some examples, the profiles in 310 may include unobscured images that allow the browsing user to see a selected image of the profile-user. If the browsing user selects a profile in 310, an obscured image or other information can be presented in 320 along with a question associated with that image/information (e.g. for a 1^{st} level). In 320, possible answers to the question may also be presented, or a blank field may be provided for the browsing user to enter an answer. In 330, the application may present the browsing user with an unobscured version of the image, or other information, from 320 based on a correct answer to the associated question presented in 320. This process may substantially repeat any number of times through presentation of various levels of obscured images/information, e.g. in 340, and presenting unobscured/unlocked versions of the image(s)/information in 350, etc. The browsing user may also return to 310 at any time and select a new profile to unravel. As mentioned previously, systems may be configured to send an alert to a profile-user at any of 310-350 while their profile is being browsed or unraveled by another user, e.g. to allow the profile-user to access and/or unravel the browsing user's profile and/or to initiate communication between users.

The various communications, determinations, and related functions described herein may be accomplished, for example, via a computer network, including the Internet and/or various WAN, LAN, Wifi or other network(s), and the results of the described processing performed by server systems may be displayed, stored and/or distributed according to known techniques. The network may include any number of communication components including wired, cellular, satellite, optical and/or other similar communication links.

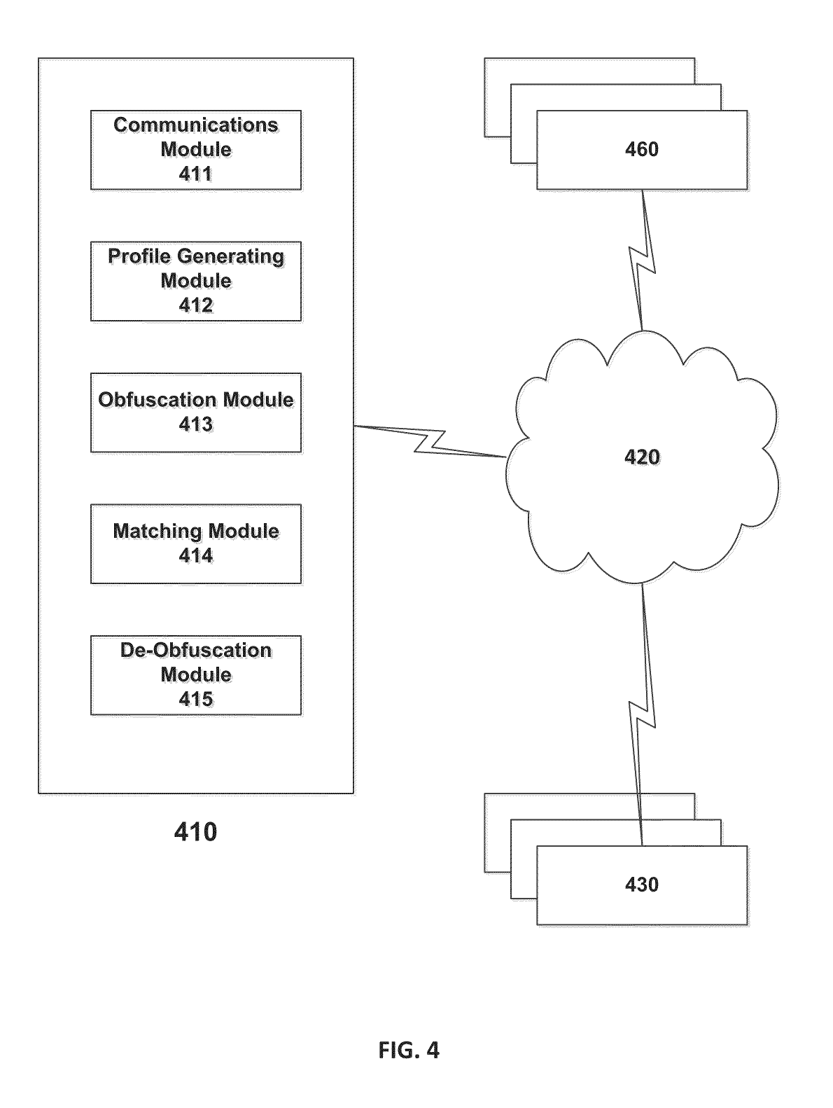

An exemplary network-enabled computer system is shown schematically in FIG. 4. As shown in FIG. 4 an exemplary server 410, in communication via the Internet 420 (or other network link) with various user devices 430 (e.g. home computers, laptops, tablet computers, smartphones, etc.) and/or other service provider servers 460 (such as social media, gaming or other servers). The server 410 (as well as user devices 430) may include any number of processors that are coupled to storage devices (e.g., random access memory, or “RAM,” and read only memory, or “ROM”). The storage devices may include any suitable type of computer-readable media, including non-transitory storage media such as flash drives, hard disks, floppy disks, magnetic tape, optical media such as CD-ROM disks, and/or magneto-optical media. The server 400 and user devices 430 may be coupled to a computer or other electronic communication network, e.g. the Internet 450, using a network connection. The network can connect various wired, optical, electronic and other known networks to exchange information among servers, computers, separate server, mobile device(s), picocell network devices, mobile computer(s), and any other devices with similar functionality. With such a network connection, it is contemplated that the servers, computers, and other mobile devices and the processors therein may receive information from the network, or may output information to the network in the course of performing the method steps described herein. The above-described devices and materials will be familiar to those of skill in the computer hardware and software arts and need not be individually or exhaustively depicted to be understood by those of skill in the art. The hardware elements described above, including elements of servers, computers, and other mobile devices, may be configured to act as one or more modules for performing the operations described above. For example, the server 410 may include a communications module 411 configured to configured to exchange information with the plurality of users over the network; a profile generating module 412 configured to generate a profile including user information, answers to one or more questions, and/or a plurality of images associated with a first user; an obfuscation module 413 configured to obscure at least one of the plurality of images; a matching module 414 configured to present a plurality user profiles to a second user, and to receive a selection of at least one of the user profiles from the second user; and/or a de-obfuscation module 415 configured to present the obscured version of the at least one image to the second user, to present at least one of the questions to the second user, and to present an unobscured version of the at least one image to the second user based on receiving an answer to the at least one of the questions.

As will be appreciated, although a Web-based environment is used for purposes of explanation, different environments may be used, as appropriate, to implement various embodiments. The user device 430 can include any device operable to send and receive requests, or information over Internet 420 or other network, and convey information to a user of the device, e.g. audio, image, video, etc. Examples of such devices may include personal computers, cell phones, handheld messaging devices, laptop computers, set-top boxes, personal data assistants, electronic book readers and the like.

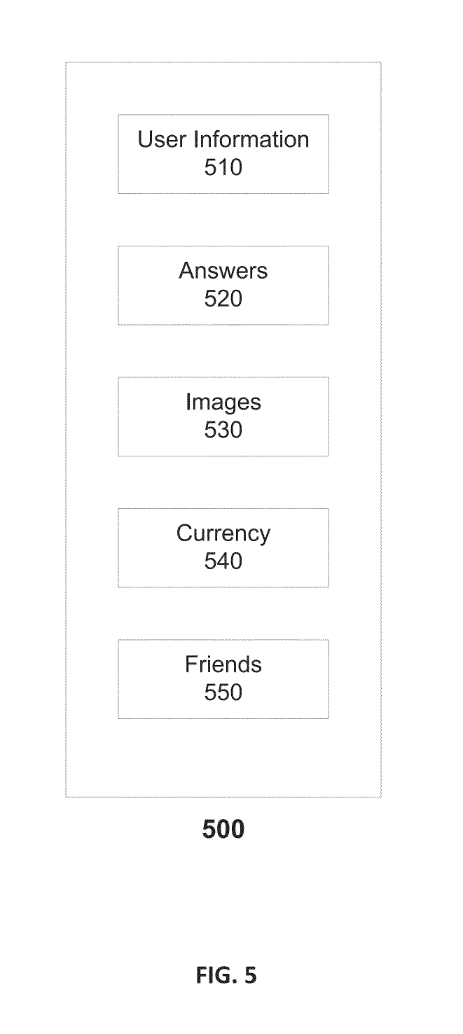

The server 410 may be configured to provide, serve, or otherwise support applications and/or web pages displayed on the user devices 430, including any of the various GUI and applications discussed herein. The server may also generate and/or store user profiles as discussed herein. Aspects of an exemplary user profile 500 are shown in FIG. 5, including user information 510, answers (and/or questions) 520, images (and/or video or other information) 530, currency 540 and friends 550.

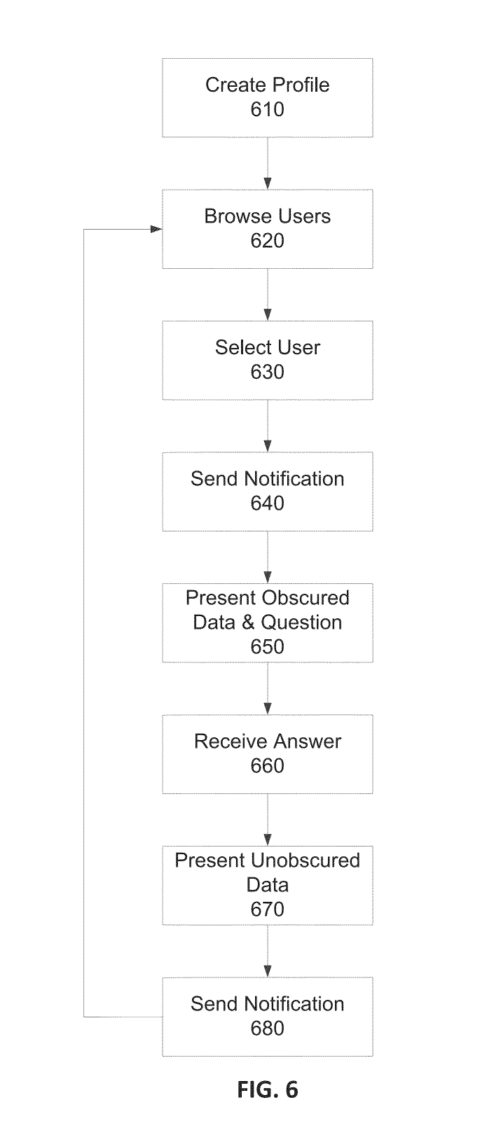

FIG. 6 shows an overview of a user process flow according to aspects of the invention. As with each of the process flows described previously, operation depicted therein may represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes. Additionally, any specific reference to one or more operations being capable of being performed in a different order is not to be understood as suggesting that other operations may not be performed in another order.

The process 600 may begin with 610, in which a user profile is created. As discussed herein, this can include interaction of a user device and service-provide server, and may include collection of various answers, user settings, information, images, videos or other data, such as described in the context of FIG. 2.

The process may optionally continue with 602, in which a user may be allowed to browse other users' accessible profile information, e.g. profile pictures, name, location, interests, etc. However, any of such data may be obscured at this point, e.g. depending on user preferences, and subject to unravelling, as discussed further herein.

The process may optionally continue with 630, in which the browsing user selects another user to “unravel.”

The process may optionally continue with 640, in which a notification may be sent to the requested user. This may include allowing the requested user to start a mutual unravel, and/or to approve the requesting user be allowed to proceed.

The process may optionally continue with 650, in which a question and obscured information may be presented to the requesting user. In some examples, the image or other data are obscured on the server side, e.g. in order to prevent the requesting user to receive unobscured data until the necessary requirements are met.

The process may optionally continue with 660, in which an answer to the question is received from the user. Depending on whether the answer is correct, i.e. it corresponds with the answer associated with the question, various actions may be taken. For example, a requesting user may be granted access to an unobscured version of the image or other data provided in 650, the requesting user may be awarded virtual currency for answering correctly, the user may be presented with another question to unlock additional levels, etc. In some examples, incorrect answers may also be used, for example, to deduct virtual currency, trigger additional questions, allow the user to guess again, or partially unlock information.

The process may optionally continue with 670, in which an unobscured version of the image or other data is presented to the requesting user. The unobscured version may correspond to the original version that was uploaded by the user in 610, and/or it may be modified in some other way, e.g. formatted to the requesting user's device, preferences, etc.

The process may optionally continue with 680, in which a notification may be sent to the requested user that the requesting user has successfully unraveled the information presented in 670. This may be done in various ways known in the art, e.g. via IM, email, gaming chat, native application function, etc.

The process may optionally return to 620, allowing the user to continue browsing other users and/or user information.

In addition, embodiments of the present invention further include computer-readable storage media that include program instructions for performing various computer-implemented operations as described herein. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While various embodiments have been described above, it is to be understood that the examples and embodiments described above are for illustrative purposes only and that various modifications or changes in light thereof will be suggested to persons skilled in the art, and are to be included within the spirit and purview of this application and scope of the appended claims. Therefore, the above description should not be understood as limiting the scope of the invention as defined by the claims.

What is claimed is:

1. A computerized system configured to exchange information among a plurality of users over a network, and comprising one or more of:
a network communication module configured to exchange information with the plurality of users over the network;
a profile generating module configured to generate a profile including user information, answers to one or more questions, and/or a plurality of images associated with a first user;
an obfuscation module configured to obscure at least one of the plurality of images;
a matching module configured to present a plurality user profiles to a second user, and to receive a selection of at least one of the user profiles from the second user; and/or
a de-obfuscation module configured to present the obscured version of the at least one image to the second user, to present at least one of the questions to the second user, and to present an unobscured version of the at least one image to the second user based on receiving an answer to the at least one of the questions,
wherein the matching module is further configured to send an alert to the user associated with the selected user profile based on at least one of presenting the obscured version of the at least one image to the second user, presenting the question to the second user, receiving the answer to the at least one of the questions, and/or presenting the unobscured version of the at least one image to the second user, and
wherein the alert includes instructions that are operable to allow the second user to initiate communication with the first user.

2. The system of claim 1, wherein the network communication module is configured to exchange information with mobile applications being operated by the plurality of users.

3. The system of claim 1, wherein the profile generating module is configured to associate specific questions with specific images such that answering a specific question unlocks the image associated with that question.

4. The system of claim 1, wherein the obfuscation module is configured to obscure the at least one of the plurality of images by blurring the image, changing color, brightness and/or hue of the image, changing the resolution of the image, or other image processing techniques.

5. The system of claim 1, wherein the matching module is configured to present the plurality of user profiles to the second user based on an algorithm that compares user and/or usage information about the second user with user and/or usage information associated with the plurality of user profiles.

6. The system of claim 1, wherein the de-obfuscation module is configured to present the unobscured version of the at least one image to the second user regardless of whether the received answer is correct, and to award virtual currency points to the second user based on a correct answer.

7. The system of claim 1, wherein the user profiles each include a plurality of images associated with each user, and each of the pictures can be unlocked by second users answering a question associated with each picture.

8. A computerized system configured to exchange information among a plurality of users over a network, comprising:
a network communication module configured to exchange information with the plurality of users over the network;
a profile generating module configured to generate a profile including user information, answers to one or more questions, and/or a plurality of images associated with a first user;
an obfuscation module configured to obscure at least one of the plurality of images;
a de-obfuscation module configured to present an obscured version of the at least one image to a second user, to present at least one of the questions to the second user, and to present the unobscured version of the at least one image to the second user based on receiving an answer to the at least one of the questions.

9. A computerized system configured to exchange information among a plurality of users over a network, comprising:
a matching module configured to present a plurality user profiles to a first user, and to receive a selection of at least one of the user profiles from the first user; and
a game module configured to present first information related to the selected profile, and to allow the first user to obtain additional information related to the selected profile via at least one of answering one or more questions or performing one or more tasks,
wherein the matching module is further configured to send an alert to a second user associated with the selected user profile based on at least one of the first information being presented to the first user and/or the first user attempting to obtain the additional information,
wherein the alert includes instructions that are operable to allow the second user to initiate communication with the first user.

10. A computerized system configured to exchange information among a plurality of users over a network, comprising:
a network communication module configured to exchange information with the plurality of users over the network;
a profile generating module configured to generate profiles for each of the users including user information, answers to one or more questions, and/or a plurality of images associated each user;
a matching module configured to present a plurality user profiles to a first user, and to receive a selection of at least one of the user profiles from the first user;
a de-obfuscation module configured to present first information related to the selected profile, and to allow the first user to obtain additional information related to the selected profile via answering one or more questions;
wherein the matching module is further configured to send an alert to a second user associated with the selected user profile based on at least one of the first information being presented to the first user and/or the first user attempting to obtain the additional information,
wherein the alert includes instructions that are operable to allow the second user to initiate communication with the first user.

11. A computerized method comprising one or more steps of:
exchanging information with a plurality of users over a network;
generating a profile including user information, answers to one or more questions, and/or a plurality of images associated with a first user;
obscuring at least one of the plurality of images;
presenting a plurality user profiles to a second user;
receiving a selection of at least one of the user profiles from the second user;
presenting the obscured version of the at least one image to the second user;
presenting at least one of the questions to the second user; and
presenting an unobscured version of the at least one image to the second user based at least in part on receiving an answer to the at least one of the questions.

12. The method of claim 11, further comprising sending an alert to the user associated with the selected user profile based on at least one of presenting the obscured version of the at least one image to the second user, presenting the question to the second user, receiving the answer to the at least one of the questions, and/or presenting the unobscured version of the at least one image to the second user.

13. The method of claim 11, wherein specific questions are associated with specific images such that answering a specific question allows presentation of the unobscured version of the image associated with that question.

14. The method of claim 11, wherein obscuring the at least one of the plurality of images includes at least one of blurring the image, changing color, brightness and/or hue of the image, or changing the resolution of the image.

15. The method of claim 11, wherein presenting the plurality of user profiles to the second user is based at least in part on an algorithm that compares user and/or usage information about the second user with user and/or usage information associated with the plurality of user profiles.

16. The method of claim 11, wherein the unobscured version of the at least one image is presented to the second user regardless of whether the received answer is correct, the method further comprising awarding virtual currency points to the second user based on receiving a correct answer to the question.

17. The method of claim 11, further comprising awarding virtual currency points to the second user based on receiving a correct answer to the question.

18. The method of claim 11, wherein the user profiles each include a plurality of images associated with each user, and each of the pictures can be unlocked by second users answering a question associated with each picture.
